(19) United States
(12) Patent Application Publication
(10) Pub. No.: US 2025/0057138 A1
(43) Pub. Date: Feb. 20, 2025

(54) Flying Insect Baiting Apparatus

(71) Applicant: Bryan Martin, Vacaville, CA (US)

(72) Inventor: Bryan Martin, Vacaville, CA (US)

(21) Appl. No.: 18/805,250

(22) Filed: Aug. 14, 2024

Related U.S. Application Data
(60) Provisional application No. 63/519,485, filed on Aug. 14, 2023.

(51) Int. Cl. A01M 1/02; A01M 1/20

(52) U.S. Cl. CPC A01M 1/02; A01M 1/2016; A01M 2200/012

(57) ABSTRACT

A flying insect baiting apparatus includes a base, a lid, and a baiting substance. The base comprises a chamber. The chamber has a top opening. The lid is attached to the base to close the top opening of the chamber. The base further comprises a baiting hole that allows flying insects to enter and exit from the chamber. The baiting substance is retained in the chamber to attract the flying insects. The baiting substance is configured to be consumed by the flying insect and allow the flying insects to survive long enough to carry the baiting substance back to a nest.

### FIELD OF THE INVENTION

The present invention relates generally to a flying insect baiting apparatus. More specifically, the present invention is a device that attracts flying insects, especially wasps, ensuring they take the bait back to their nest.

### BACKGROUND OF THE INVENTION

Wasp traps are specialized containers designed to attract and trap wasps, providing an effective solution for controlling these stinging insects. These traps are crafted with a combination of materials and design that lure wasps in with enticing baits such as sugary liquids. Once inside the trap, the wasps find it difficult to escape due to the structure of the trap. Wasp traps are commonly used in outdoor settings, especially during warmer months when wasp activity is high. They offer a non-toxic and environmentally friendly alternative to chemical sprays, contributing to natural pest control. By targeting wasps specifically, these wasp traps help reduce their population and reduce the risk of stings, creating a safer and more enjoyable outdoor experience. Unfortunately, most wasp traps do not address the problem of the wasp nest still being active, allowing nearby wasps to still return to the area.

Therefore, it is an objective of the present invention to provide a wasp baiting apparatus that overcomes the problems set forth above.

### SUMMARY OF THE INVENTION

The present invention discloses a flying insect baiting apparatus. It comprises a base, a lid, and a baiting substance. The base comprises a chamber. The chamber has a top opening. The lid is attached to the base to close the top opening of the chamber. The base further comprises a baiting hole that allows flying insects to enter and exit from the chamber. The baiting substance is retained in the chamber to attract the flying insects. The baiting substance is configured to be consumed by the flying insect and allow the flying insects to survive long enough to carry the baiting substance back to a nest.

In one embodiment, the base comprises a first attachment member, and the lid comprises a complementary second attachment member.

In one embodiment, the first attachment member and the second attachment member are threads.

In one embodiment, the lid further comprises a loop member.

In one embodiment, the loop member comprises a loop portion and a shank portion.

In one embodiment, the lid comprises a lid hole that allows the shank portion to run through, and the shank portion comprises an enlarged end.

In one embodiment, the loop member further comprises a loop adjustment mechanism configured to adjust a size of the loop portion.

In one embodiment, the base further comprises a sidewall, and the baiting hole is located at the sidewall.

In one embodiment, the base is made from a transparent material.

In one embodiment, the base has a cylindrical shape.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the present invention.

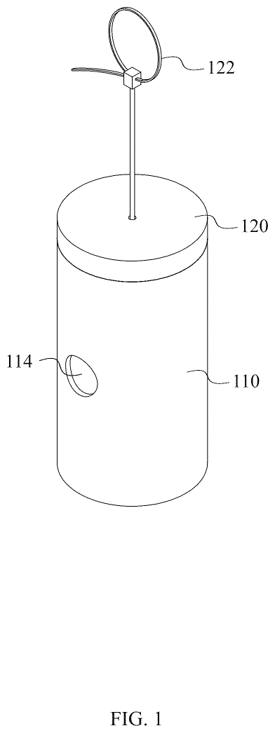

FIG. 2 depicts a front view of the present invention.

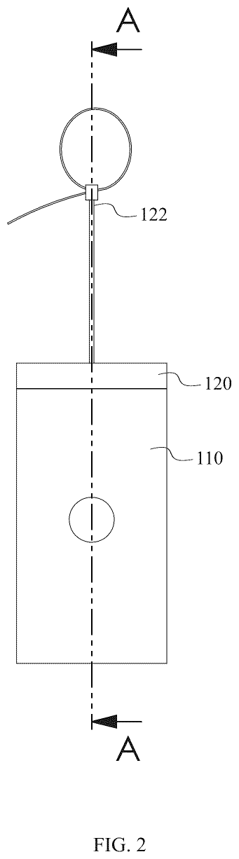

FIG. 3 depicts a cross-sectional view of the present invention, taken along the line A-A in FIG. 2.

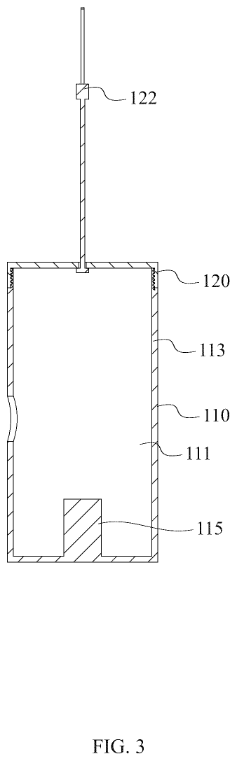

FIG. 4 depicts a perspective view of the base of the present invention.

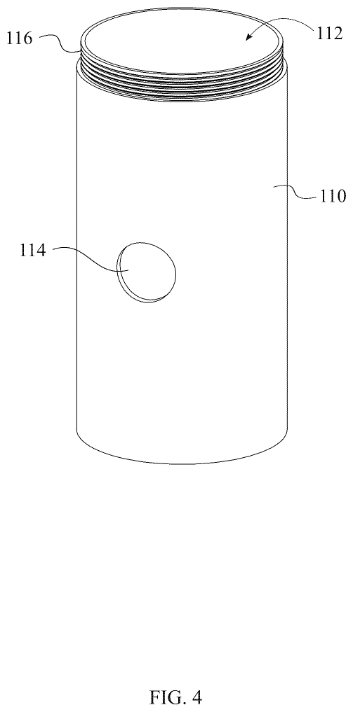

FIG. 5 depicts a perspective view of the lid of the present invention.

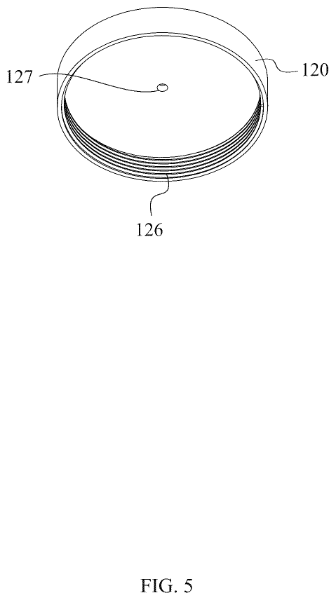

FIG. 6 depicts a perspective view of the loop member of the present invention.

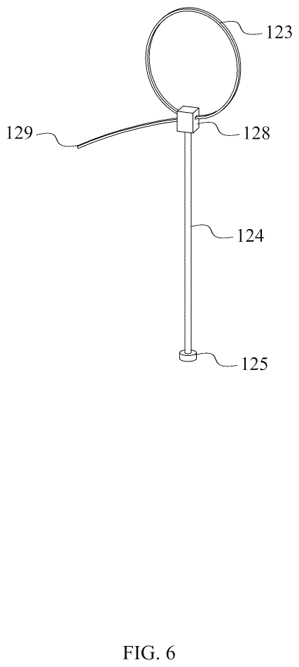

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of flying insect baiting apparatuses, embodiments of the present disclosure are not limited to use only in this context.

The present invention is a flying insect baiting apparatus that is specifically designed to lure and eliminate wasps. It is an aim of the present invention to provide a baiting apparatus that eliminates nearby wasps and their nesting location. It is another aim of the present invention to provide a baiting apparatus that can be easily deployed outdoors.

Referring now to the figures of the present disclosure. The flying insect baiting apparatus of the present invention comprises a base 110, a lid 120, and a baiting substance 130.

The base 110 is configured to accommodate the baiting substance 130 that will lure and kill the wasps. It should be noted that the base 110 can be of any shape, size, material, features, type or kind, orientation, location, quantity, components, and arrangements of components that would allow the present invention to fulfill the objectives and intents of the present invention. In one embodiment, the base comprises a chamber 111. The chamber 111 has a top opening 112. The chamber 111 is configured to accommodate the baiting substance 130. In one embodiment, the base 110 further comprises a baiting hole 114 that allows flying insects to enter and exit from the chamber 111. In one embodiment, the base further comprises a sidewall 113, and the baiting hole 114 is located at the sidewall 113. Preferably, the bait hole 114 is designed with a circular shape to allow wasps to enter and leave chamber 111. In one embodiment, the base 110 is made from a transparent material to allow a user to see what is within the apparatus from the outside. However, it should be noted that the base 110 can also be made from opaque or translucent materials. In a preferred embodiment, the base 110 has a cylindrical shape. However, it is contemplated that other shapes, such as regular or irregular polygons, are also possible. In one embodiment, the present invention may further comprise a warning label. The warning label may be a sticky label that is positioned on the sidewall 113 of the base 110, displaying a warning about the contents within the base 110.

The lid 120 is attached to the base 110 to close the top opening 112 of the chamber 111 such that the only entry point for the wasps is through the bating hole 114 when the lid 120 and the base 110 are attached together. It should be noted that the lid 120 can be of any shape, size, material, features, type or kind, orientation, location, quantity, components, and arrangements of components that would allow the present invention to fulfill the objectives and intents of the present invention. The lid 120 may be made from a material that is the same as or different from the base 110. The lid 120 can be attached to the base 110 via any suitable means. In one embodiment, the base 110 comprises a first attachment member 116, and the lid 120 comprises a complementary second attachment member 126. Preferably, the first attachment member 116 and the second attachment member 126 are threads, such that the lid 120 may thread into the base 120. In a preferred embodiment, the lid 120 further comprises a loop member 122. The loop member 122 allows the apparatus of the present to be secured to various external objects, such as a tree branch. Preferably, the loop member 122 is made from a metal wire material. The loop member 122 comprises a loop portion 123 and a shank portion 124. The loop member can be coupled to the lid 120 via any suitable methods. In one embodiment, the lid 120 comprises a lid hole 127 that allows the shank portion 124 to run through, and the shank portion 124 comprises an enlarged end 125. In one embodiment, the loop member 122 further comprises a loop adjustment mechanism 128 configured to adjust a size of the loop portion 123. For example, the loop adjustment mechanism 128 may function like a zip tie, allowing the free end 129 of the loop portion 123 to pass through and secure the loop portion 123 at the desired size. This design enables the present invention to attach to external objects, such as tree branches, of various sizes.

The baiting substance 130 is retained in the chamber 111 to attract the flying insects. The baiting substance 130 is further configured to be consumed by the flying insect and allow the flying insects to survive long enough to carry the baiting substance back to a nest. The baiting substance 130 is a wasp bait that kills the wasp over a period of time ensuring the wasp has time to return back to the nest with the baiting substance 130 and spread it throughout the nest.

It is envisioned that the sizes of the components forming the present invention such as the base 110 and/or the lid 120 can vary based on design requirements.

Although the disclosure has been explained in relation to its preferred embodiment, it is to be understood that many other possible modifications and variations can be made without departing from the spirit and scope of the disclosure.

What is claimed is:

1. A flying insect baiting apparatus comprising:
a base;
a lid;
a baiting substance;
the base comprising a chamber;
the chamber having a top opening;
the lid being attached to the base to close the top opening of the chamber;
the base further comprising a baiting hole that allows flying insects to enter and exit from the chamber;
the baiting substance being retained in the chamber to attract the flying insects;
the baiting substance being configured to be consumed by the flying insect and allow the flying insects to survive long enough to carry the baiting substance back to a nest.

2. The flying insect baiting apparatus as claimed in claim 1, wherein the base comprises a first attachment member, and the lid comprises a complementary second attachment member.

3. The flying insect baiting apparatus as claimed in claim 2, wherein the first attachment member and the second attachment member are threads.

4. The flying insect baiting apparatus as claimed in claim 1, wherein the lid further comprises a loop member.

5. The flying insect baiting apparatus as claimed in claim 4, wherein the loop member comprises a loop portion and a shank portion.

6. The flying insect baiting apparatus as claimed in claim 5, wherein the lid comprises a lid hole that allows the shank portion to run through, and the shank portion comprises an enlarged end.

7. The flying insect baiting apparatus as claimed in claim 5, wherein the loop member further comprises a loop adjustment mechanism configured to adjust a size of the loop portion.

8. The flying insect baiting apparatus as claimed in claim 1, wherein the base further comprises a sidewall, and the baiting hole is located at the sidewall.

9. The flying insect baiting apparatus as claimed in claim 1, wherein the base is made from a transparent material.

10. The flying insect baiting apparatus as claimed in claim 1, wherein the base has a cylindrical shape.
